(19) United States
(12) Patent Application Publication
(10) Pub. No.: US 2026/0356247 A1
(43) Pub. Date: Nov. 12, 2026

(54) CONTROL DEVICE FOR VEHICLE AND CONTROL METHOD FOR VEHICLE

(71) Applicant: HONDA MOTOR CO., LTD., TOKYO (JP)

(72) Inventor: Kyohei ISHIDA, WAKO-SHI (JP)

(21) Appl. No.: 19/666,536

(22) Filed: May 4, 2026

(30) Foreign Application Priority Data
May 12, 2025 (JP) 2025-080045

(51) Int. Cl. B60L 58/40; B60L 7/10; B60L 50/75; B60L 58/33; H01M 8/04298

(52) U.S. Cl. CPC B60L 58/40; B60L 7/10; B60L 50/75; B60L 58/33; H01M 8/04298; B60L 2240/54; B60L 2240/62; H01M 2250/20

(57) ABSTRACT

In a case where a predicted regenerative electric power amount in a first charging section is larger than a predicted motoring electric power amount in a motoring section, a charge/discharge control unit regards a section obtained by combining the first charging section, the motoring section, and a second charging section following the motoring section, as a combined control section in which charge and discharge control is performed on a power storage device. Before a vehicle reaches a start point of the combined control section, an amount of electric power generated by a fuel cell system is controlled based on a predicted charge and discharge electric power amount in the combined control section in a manner so that a charge margin allowing the power storage device to be charged with the predicted regenerative electric power amount in the combined control section remains in the power storage device.

### CROSS-REFERENCE TO RELATED APPLICATIONS

This application is based upon and claims the benefit of priority from Japanese Patent Application No. 2025-080045 filed on May 12, 2025, the contents of which are incorporated herein by reference.

### BACKGROUND OF THE INVENTION

### Field of the Invention

The present disclosure relates to a control device for a vehicle provided with a fuel cell system including a fuel cell that generates electric power using an oxygen-containing gas and a fuel gas, and a control method for the vehicle.

### Description of the Related Art

In recent years, research and development have been conducted on fuel cells (FCs) that contribute to energy efficiency, in order to ensure that more people have access to affordable, reliable, sustainable and modern energy. Meanwhile, vehicles equipped with the fuel cells (fuel cell vehicles) and electric vehicles are also running on public roads.

The fuel cell vehicle and the electric vehicle are configured to travel using a motor generator for improving fuel efficiency, and to charge the power storage device with regenerative electric power generated by the motor generator.

For example, JP 2017-144801 A discloses an electric vehicle including a motor generator, a power storage device, a power generation device, and a charging control unit that controls the operation of the power generation device.

JP 2017-144801 A discloses that the electric vehicle can calculate the electric power consumption during traveling along a route based on map information including data such as a gradient and information about the route obtained from a navigation device.

### SUMMARY OF THE INVENTION

Incidentally, the fuel cell vehicle has advantages that the hydrogen filling time is shorter and the cruising distance per filling is longer than the charging time and the cruising distance of the electric vehicle.

However, regarding the vehicle equipped with the fuel cell system, there is a problem that complicated charge and discharge control is required for the power storage device.

The present disclosure has the object of solving the above-described problem.

One aspect of the present disclosure is characterized by a control device for a vehicle, the vehicle including: a fuel cell system including a fuel cell configured to generate electric power by using an oxygen-containing gas and a fuel gas; a motor generator driven by electric power that is generated by the fuel cell system, the motor generator being configured to consume motoring electric power; a power storage device configured to be charged with the electric power generated by the fuel cell system and regenerative electric power generated by the motor generator during regenerative braking; and a charge/discharge control unit configured to control the electric power generated by the fuel cell system, the motoring electric power of the motor generator, the regenerative electric power of the motor generator, a remaining capacity of the power storage device, and a charge and discharge electric power amount of the power storage device, wherein in a case where a planned travel route of the vehicle includes a first charging section which is located ahead of the vehicle and in which the motor generator generates the regenerative electric power, a motoring section which is located ahead of the first charging section and in which the motor generator consumes the motoring electric power, and a second charging section which is located ahead of the motoring section and in which the motor generator generates the regenerative electric power, the charge/discharge control unit regards a section obtained by combining the first charging section, the motoring section, and the second charging section as a combined control section in which charge and discharge control is performed on the power storage device, in a case where a predicted regenerative electric power amount in the first charging section is larger than a predicted motoring electric power amount in the motoring section, and before the vehicle reaches a start point of the combined control section, the charge/discharge control unit controls an amount of the electric power generated by the fuel cell system based on a predicted charge and discharge electric power amount in the combined control section, in a manner so that a charge margin allowing the power storage device to be charged with the predicted regenerative electric power amount in the combined control section remains in the power storage device.

Another aspect of the present disclosure is characterized by a control method for a vehicle, the vehicle including: a fuel cell system including a fuel cell configured to generate electric power by using an oxygen-containing gas and a fuel gas; a motor generator driven by electric power that is generated by the fuel cell system, the motor generator being configured to consume motoring electric power; a power storage device configured to be charged with the electric power generated by the fuel cell system and regenerative electric power generated by the motor generator during regenerative braking; and a charge/discharge control unit configured to control the electric power generated by the fuel cell system, the motoring electric power of the motor generator, the regenerative electric power of the motor generator, a remaining capacity of the power storage device, and a charge and discharge electric power amount of the power storage device, the control method comprising, in a case where a planned travel route of the vehicle includes a first charging section which is located ahead of the vehicle and in which the motor generator generates the regenerative electric power, a motoring section which is located ahead of the first charging section and in which the motor generator consumes the motoring electric power, and a second charging section which is located ahead of the motoring section and in which the motor generator generates the regenerative electric power: a step of causing the charge/discharge control unit to regard a section obtained by combining the first charging section, the motoring section, and the second charging section as a combined control section in which charge and discharge control is performed on the power storage device, in a case where a predicted regenerative electric power amount in the first charging section is larger than a predicted motoring electric power amount in the motoring section; and a charge and discharge control step of, before the vehicle reaches a start point of the combined control section, causing the charge/discharge control unit to control an amount of the electric power generated by the fuel cell system based on a predicted charge and discharge electric power amount in the combined control section, in a manner so that a charge margin allowing the power storage device to be charged with the predicted regenerative electric power amount in the combined control section remains in the power storage device.

According to the present disclosure, it is possible to simplify complicated charge and discharge control for a power storage device in a vehicle equipped with a fuel cell system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic block diagram showing an example of a configuration of a vehicle including a control device for the vehicle according to an embodiment of the present disclosure, which performs a control method for the vehicle according to the embodiment;

FIG. 2 is a schematic diagram explaining a remaining capacity of a power storage device;

FIG. 3 is a schematic configuration diagram of the vehicle in which a fuel cell system is incorporated;

FIG. 4 is a flowchart (1/2) for explaining the operation of the control device for the vehicle shown in FIGS. 1 and 3;

FIG. 5 is a flowchart (2/2) for explaining the operation of the control device for the vehicle shown in FIGS. 1 and 3;

FIG. 6 is a distance-altitude schematic diagram showing a change in altitude of a planned travel route of the vehicle and the like;

FIG. 7 is a schematic diagram of a change in remaining capacity over distance in which a change state of the remaining capacity of the power storage device is added on the vertical axis in FIG. 6; and

FIG. 8 is a schematic diagram explaining a charge margin required for the power storage device at a travel start point of a combined control section.

### DETAILED DESCRIPTION OF THE INVENTION

### EMBODIMENTS

### Configuration

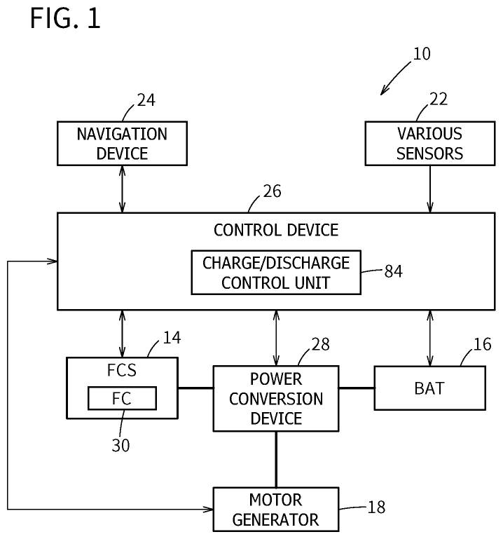

FIG. 1 is a schematic block diagram showing an example of a configuration of a vehicle 10 including a control device 26 for the vehicle 10 according to an embodiment of the present disclosure, which performs a control method for the vehicle 10 according to the embodiment.

The vehicle 10 shown in FIG. 1 is a fuel cell vehicle. As shown in FIG. 1, the vehicle 10 includes a fuel cell system (FCS) 14, a power storage device (BAT) 16, a motor generator 18, a power conversion device 28, various sensors 22, a navigation device 24, and the control device 26.

In FIG. 1, a thick solid line indicates an electric power line, and a thin solid line indicates a signal line.

The fuel cell system 14 includes a fuel cell stack (also simply referred to as a fuel cell) (FC) 30 that generates electric power by an electrochemical reaction between a fuel gas and an oxygen-containing gas.

The motor generator 18 is an AC motor (three-phase synchronous motor). The main shaft of the motor generator 18 is rotated by three-phase AC electric power (motoring or powering electric power) obtained by the power conversion device 28 converting at least one of the generated electric power of the fuel cell system 14 or the stored electric power of the power storage device 16, each of which is DC electric power. By the rotation of the main shaft, wheels (not shown) are rotationally driven (power-driven), and the vehicle 10 travels.

The power storage device 16 is a chargeable and dischargeable secondary battery. The power storage device 16 generates a high voltage by electrically connecting power storage cells in series, and a lithium ion battery, a nickel hydrogen battery, or the like can be used as the power storage cell. A capacitor may be used as the power storage device 16.

The motor generator 18 generates electric power by regenerative operation (performs regenerative electric power generation) during braking of the vehicle 10. The electric power (three-phase AC regenerative electric power) generated at an AC terminal of the power conversion device 28 by the regenerative electric power generation is converted into DC electric power (DC regenerative electric power) at a DC terminal 35 via the power conversion device 28, and the power storage device 16 is charged with the DC electric power.

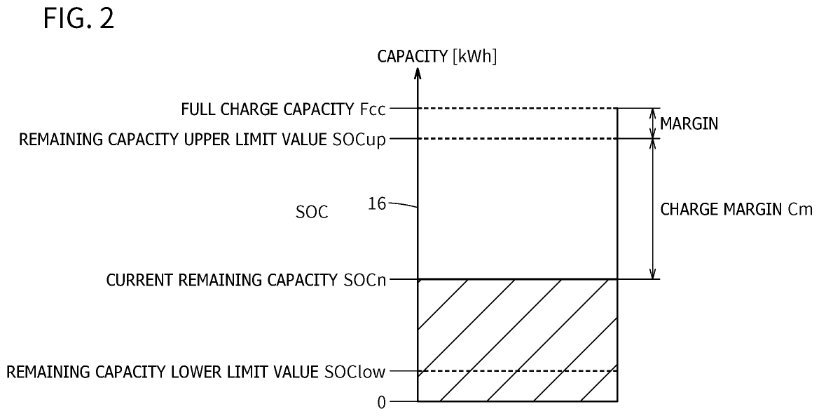

FIG. 2 is a schematic diagram explaining a remaining capacity (state of charge) SOC [kWh] of the power storage device 16. The hatched region indicates a current remaining capacity SOCn [kWh] of the power storage device 16 with respect to a full charge capacity Fcc thereof.

In order to protect the power storage device 16 from overcharging (to suppress deterioration thereof), the remaining capacity obtained by subtracting a margin [kWh] from a full charge capacity Fcc [kWh] is set in advance as a remaining capacity upper limit value SOCup [kWh], which is an upper limit value of the remaining capacity SOC [kWh]. Further, in order to protect the power storage device 16 from overdischarging (to suppress deterioration thereof), a remaining capacity lower limit value SOClow, which is a lower limit value of the remaining capacity SOC, is set in advance.

A difference obtained by subtracting the current remaining capacity SOCn from the remaining capacity upper limit value SOCup is a charge margin Cm [kWh]. This relationship is shown in Expressions (1) and (2).

charge margin Cm=remaining capacity upper limit value SOCup−current remaining capacity SOCn (1)

remaining capacity upper limit value SOCup=current remaining capacity SOCn+charge margin Cm (2)

In the present embodiment, in the case where the remaining capacity obtained by adding the charging electric power such as the regenerative electric power to the current remaining capacity SOCn exceeds the remaining capacity upper limit value SOCup, the excess charging electric power such as the regenerative electric power is consumed by auxiliary devices (an auxiliary device) 42 of the fuel cell system 14, which will be described later, without being supplied to the power storage device 16 under the control of the control device 26.

Returning to FIG. 1, the various sensors 22 include, for example, a vehicle speed sensor that detects a speed of the vehicle 10 (also referred to as a vehicle speed), an accelerator operation amount sensor that detects the amount of operation on an accelerator pedal of the vehicle 10, and a power storage device sensor that detects various types of information relating to the power storage device 16 (for example, a power storage voltage Vb, a battery current Ib (a charge current Ibc and a discharge current Ibd), and a temperature).

The results of detection by the various sensors 22 are transmitted to the control device 26 as detection signals. The detection signals are acquired by the control device 26.

As is known, the navigation device 24 includes a storage device that stores map data and the like, a GNSS receiver that can identify the position of the vehicle 10 (also referred to as an own vehicle position) based on signals received from positioning satellites, a display that displays various types of information, operation buttons (including a touch panel) that receive operations from a user (for example, a driver) of the vehicle 10, and the like.

The map data of the navigation device 24 includes road data relating to roads. In the road data, each road is divided into predetermined sections, and the road data includes information about links corresponding to the respective sections, and nodes connecting the links. Further, the road data includes, in association with each link, attribute information indicating a regulated speed (for example, a legal speed) of a section corresponding to the link, a gradient of a traveling road (road), and the like.

The navigation device 24 determines route information (guidance route information) from the own vehicle position to a destination set by the user of the vehicle 10, by referring to the map data and the like. The navigation device 24 guides the user to the determined guidance route by displaying the guidance route on the display.

The navigation device 24 also predicts a planned travel route Dp of the vehicle 10 by referring to the own vehicle position, the traveling direction of the vehicle 10, the destination that has been set, the map data, and the like.

Upon predicting the planned travel route Dp, the navigation device 24 transmits route information about the planned travel route Dp to the control device 26. This route information includes three dimensional position information indicating each section included in the planned travel route Dp and the attribute information (the regulated speed, gradient, and the like) of each section.

As a result, the navigation device 24 can notify the control device 26 of the three dimensional position information of each section included in a planned travel section Ds corresponding to the planned travel route Dp, and the attribute information such as the regulated speed and the gradient of the section. Further, the navigation device 24 notifies the control device 26 of the own vehicle position, as appropriate. The vehicle 10 may be an automated driven vehicle.

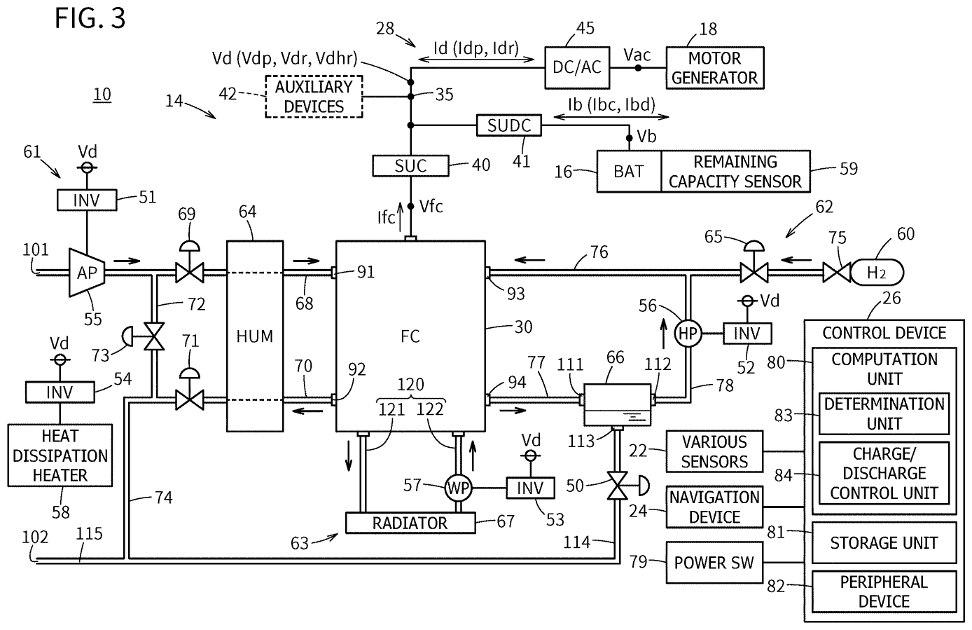

FIG. 3 is a schematic configuration diagram of the vehicle 10 in which the fuel cell system 14 is incorporated. The vehicle 10 includes the control device 26 that controls the entire vehicle 10, the fuel cell system 14, the motor generator 18 serving as a main load (main device load) electrically connected to the fuel cell system 14 and the power storage device 16, and the auxiliary devices 42 serving as auxiliary device loads of the fuel cell system 14.

The number of the control devices 26 may not be one, and two or more control devices 26 may be provided, such as a control device for the fuel cell system 14, a control device for the motor generator 18 (main load), and a control device for the auxiliary devices 42, for example.

The auxiliary devices 42 include an air pump (AP) 55, a fuel circulation pump (HP) 56, a coolant pump (WP) 57, a heat dissipation heater 58, and the like. The auxiliary devices 42 may include an air conditioner of the vehicle cabin.

The air pump 55 supplies an oxygen-containing gas to the fuel cell 30. The fuel circulation pump 56 supplies a fuel off-gas containing unreacted fuel gas to the fuel cell 30. The coolant pump 57 circulates and supplies a coolant (heat exchange medium) to the fuel cell 30. The heat dissipation heater 58 dissipates the electric power generated by the fuel cell 30 into the atmosphere as heat. Each of the auxiliary devices 42 described here consumes a relatively large amount of electric power (large electric power).

The power conversion device 28 is disposed among the motor generator 18, the auxiliary devices 42, and the power storage device 16.

The power conversion device 28 includes a DC/AC converter (DC/AC) 45, a step-up/down converter (SUDC) 41, and a step-up converter (SUC) 40.

The step-up converter 40 steps up a generated voltage Vfc of the fuel cell 30 to a DC terminal motoring voltage Vdp, which is a DC terminal voltage Vd. In order to step up an AC terminal regenerative voltage Vac generated by the motor generator 18 to a DC terminal high-voltage regenerative voltage Vdhr, the step-up converter 40 steps up the generated voltage Vfc to a DC terminal high-voltage regenerative voltage Vfhr (Vfhr=Vdhr).

First, the step-up/down converter 41 steps up the power storage voltage Vb of the power storage device 16 to the DC terminal motoring voltage Vdp, which is the DC terminal voltage Vd. Secondly, the step-up/down converter 41 steps down the DC terminal voltage Vd to the power storage voltage Vb to charge the power storage device 16. Thirdly, the step-up/down converter 41 steps down the DC terminal motoring voltage Vdp, which is obtained by stepping up the generated voltage Vfc by the step-up converter 40, to the power storage voltage Vb to charge the power storage device 16. Fourthly, the step-up/down converter 41 steps down a DC terminal regenerative voltage Vdr or the DC terminal high-voltage regenerative voltage Vdhr to the power storage voltage Vb to charge the power storage device 16.

The DC/AC converter 45 is an inverter, and converts the DC terminal motoring voltage Vdp into a three-phase AC terminal voltage (AC terminal motoring voltage) Vac to apply the AC terminal voltage Vac to the motor generator 18.

The three-phase AC terminal voltage (AC terminal regenerative voltage) Vac generated by the motor generator 18 during the regenerative operation is converted into the DC terminal regenerative voltage Vdr or the DC terminal high-voltage regenerative voltage Vdhr by the DC/AC converter 45.

The DC terminal voltage Vd (the DC terminal motoring voltage Vdp, the DC terminal regenerative voltage Vdr, or the DC terminal high-voltage regenerative voltage Vdhr) is applied to the auxiliary devices 42.

The step-up converter 40 has a known configuration, and controls ON/OFF of a generated current If flowing through a reactor by a switching element at a high frequency with a period T. In this case, as shown in Expression (3), an ON time ton in the period T is controlled to step up the generated voltage Vfc to the DC terminal voltage Vd.

Vd=[1/(1−(ton/T))]×Vfc (3)

The step-up/down converter 41 has a known configuration, and when stepping up the power storage voltage Vb, controls ON/OFF of a battery current Ib flowing through the reactor by a switching element at a high frequency with a period T, in the same manner as the step-up converter 40. In this case, as shown in Expression (4), an ON time ton in the period T is controlled to step up the power storage voltage Vb to the DC terminal voltage Vd.

Vd=[1/(1−(ton/t))]×Vb (4)

When the DC terminal voltage Vd is stepped down, the ON time ton of the switching element within the period T is controlled. In this case, as shown in Expression (5), the DC terminal voltage Vd is stepped down to the power storage voltage Vb.

Vb=(ton/T)×Vd (5)

The DC/AC converter 45 has a three-phase full bridge configuration.

During the motoring operation of the motor generator 18, the DC/AC converter 45 converts the DC terminal voltage Vd, which is a motoring voltage, into the three-phase AC terminal motoring voltage Vac, and applies the AC terminal motoring voltage Vac to a U-phase coil, a V-phase coil, and a W-phase coil of the motor generator 18.

During the regenerative operation of the motor generator 18, the DC/AC converter 45 converts the three-phase AC terminal regenerative voltage Vac generated in the U-phase coil, the V-phase coil, and the W-phase coil into the DC terminal regenerative voltage Vdr.

The DC terminal voltage Vd is converted into AC terminal voltages via inverters 51 to 54. The AC terminal voltages are respectively applied to the motor of the air pump 55, the motor of the fuel circulation pump 56, the motor of the coolant pump 57, and the heat dissipation heater 58. As a result, the motor of the air pump 55, the motor of the fuel circulation pump 56, the motor of the coolant pump 57, and the heat dissipation heater 58 are driven.

The connection of the circuit of each of the inverters 51 to 54 is the same as the connection of the circuit of the DC/AC converter 45, and thus the description thereof will be omitted.

The DC/AC converter 45 may be referred to as “an inverter for the motor generator 18”, and the inverters 51 to 54 may be referred to as “inverters 51 to 54 for the auxiliary devices 42” in order to distinguish from the inverter for the motor generator 18.

A voltage sensor (not shown) that detects the generated voltage Vfc and a current sensor (not shown) that detects the generated current Ifc are connected to the fuel cell 30 as the various sensors 22.

A voltage sensor (not shown) that detects the power storage voltage Vb and a current sensor (not shown) that detects the battery current Ib are connected to the power storage device 16 as the various sensors 22. The battery current Ib is the discharge current Ibd or the charge current Ibc.

A voltage sensor (not shown) that detects the DC terminal voltage Vd is connected as the various sensors 22 between the DC terminals (a reference voltage terminal and a voltage terminal) 35 of the DC/AC converter 45, and a current sensor (not shown) that detects a DC terminal current Id is connected to the DC terminal 35 of the DC/AC converter 45.

The DC terminal current Id is a motoring current Idp supplied to the motor generator 18 or a regenerative current Idr supplied from the motor generator 18.

It should be noted that the voltage generated between two phases of the three phases of the motor generator 18 is referred to as the AC terminal voltage (the AC terminal motoring voltage and the AC terminal regenerative voltage) Vac as described above.

The power storage device 16 is attached with, as the various sensors 22, a remaining capacity sensor 59 that measures a current remaining capacity SOCn [%], which is a state of charge of the power storage device 16.

The fuel cell system 14 includes the fuel cell 30, a hydrogen tank (fuel gas tank) 60, an oxygen-containing gas supply device 61, a fuel gas supply device 62, and a coolant supply device 63. The fuel cell 30 has a stack structure in which a plurality of power generation cells (not shown) are stacked. The oxygen-containing gas supply device 61 includes the air pump 55 and a humidifier (HUM) 64.

The fuel gas supply device 62 includes a pressure reducing valve 65, the fuel circulation pump 56, and a gas-liquid separator 66. The pressure reducing valve 65 may be replaced with an injector. The fuel circulation pump 56 may be replaced with an ejector. The coolant supply device 63 includes the coolant pump 57 and a radiator 67.

The air pump 55 is constituted by a mechanical supercharger or the like driven by a compressor motor controlled by the three-phase AC output of the inverter 51.

The air pump 55 has a function of, for example, sucking and pressurizing outside air (atmosphere, air) from an outside air intake port 101, and supplying the outside air to the fuel cell 30 through the humidifier 64.

The humidifier 64 has a function of humidifying the oxygen-containing gas supplied from the air pump 55. That is, the humidifier 64 transfers the water contained in the oxygen-containing exhaust gas (oxygen-containing off-gas) discharged from an oxygen-containing off-gas outlet 92, to the supplied gas (oxygen-containing gas) through the internal porous membranes to humidify the oxygen-containing gas, and supplies the humidified oxygen-containing gas to the fuel cell 30 through an oxygen-containing gas inlet 91.

An oxygen-containing gas supply flow path 68 extending from the outside air intake port 101 to the oxygen-containing gas inlet 91 is provided with the air pump 55, an inlet-side stop valve 69, and the humidifier 64 in this order from the outside air intake port 101. The flow paths such as the oxygen-containing gas supply flow path 68 drawn by double lines are formed by pipes (the same applies hereinafter). The inlet-side stop valve 69 opens and closes the oxygen-containing gas supply flow path 68.

An oxygen-containing off-gas discharge flow path 70 communicating with the oxygen-containing off-gas outlet 92 is provided with the humidifier 64 and an outlet-side stop valve 71 that also functions as a back pressure valve, in this order from the oxygen-containing off-gas outlet 92.

A bypass flow path 72 that connects the oxygen-containing gas supply flow path 68 and the oxygen-containing off-gas discharge flow path 70 is provided between the inlet of the inlet-side stop valve 69 and the outlet of the outlet-side stop valve 71. The bypass flow path 72 is provided with a bypass valve 73 that opens and closes the bypass flow path 72. The bypass valve 73 adjusts the flow rate of the oxygen-containing gas bypassing the fuel cell 30.

In this case, a charge/discharge control unit (control unit) 84 may control the amount of electric power generated by the fuel cell system 14 by causing the oxygen-containing gas pressurized by the air pump 55 to flow via the bypass flow path 72.

By causing a portion of the oxygen-containing gas supplied to the fuel cell 30 to flow through the bypass flow path 72, the amount of oxygen-containing gas supplied for use in electric power generation is reduced (and the amount of hydrogen consumed is also reduced at the same time), and by consuming (wasting) the amount of electric power generated by the fuel cell 30 with the air pump 55 through the inverter 51, the amount of electric power generated by the fuel cell system 14 can be adjusted. The merged path of the bypass flow path 72 and the oxygen-containing off-gas discharge flow path 70 communicates with a discharge flow path 74.

The hydrogen tank 60 includes an electromagnetically operated hydrogen shut-off valve 75, the hydrogen tank 60 being a container that stores high-purity hydrogen compressed at a high pressure.

The fuel gas (hydrogen) discharged from the hydrogen tank 60 is depressurized through the pressure reducing valve 65 provided in a fuel gas supply flow path 76, and is supplied to a fuel gas inlet 93 of the fuel cell 30.

A fuel off-gas outlet 94 of the fuel cell 30 is connected to an inlet 111 of the gas-liquid separator 66 through a fuel off-gas discharge flow path 77, and the fuel off-gas, which is a hydrogen-containing gas, is supplied from the fuel cell 30 to the inlet 111.

The gas component of the fuel off-gas is discharged from a gas discharge outlet 112 of the gas-liquid separator 66, and is supplied to the fuel gas supply flow path 76 through a circulation flow path 78 by the fuel circulation pump 56. The fuel off-gas supplied to the fuel gas supply flow path 76 merges with the fuel gas discharged from the pressure reducing valve 65, and is supplied into the fuel cell 30 from the fuel gas inlet 93.

The liquid component (liquid water) of the fuel off-gas is discharged from a liquid discharge outlet 113 of the gas-liquid separator 66, passes through a drain flow path 114 provided with a drain valve 50, is mixed with the discharged gas that is discharged from the discharge flow path 74, and is discharged into the outside air through a discharge flow path 115 and an exhaust gas exhaust port 102.

A portion of the fuel off-gas (hydrogen-containing gas) is discharged to the drain flow path 114 together with the liquid water. Further, after the discharge of the liquid water is completed, only the fuel off-gas (hydrogen-containing gas) is discharged to the drain flow path 114.

In order to dilute the hydrogen gas in the fuel off-gas and discharge the diluted hydrogen gas to the outside, a portion of the oxygen-containing gas discharged from the air pump 55 is supplied to the discharge flow path 74 through the bypass flow path 72 and the bypass valve 73.

In the case where the drain valve 50 is kept open even after the water is drained from the drain flow path 114, the hydrogen is discharged and wasted, and therefore, after the water is drained from the gas-liquid separator 66, the drain valve 50 is closed as appropriate.

The coolant supply device 63 of the fuel cell system 14 includes a coolant flow path 120 through which a coolant cla flows. The coolant flow path 120 includes a coolant supply flow path 122 and a coolant discharge flow path 121. The coolant supply flow path 122 is configured to supply the coolant to the fuel cell 30, and the coolant discharge flow path 121 is configured to discharge the coolant from the fuel cell 30. The radiator 67 is connected to the coolant supply flow path 122 and the coolant discharge flow path 121.

The radiator 67 serves to cool the coolant with the outside air. The coolant supply flow path 122 is provided with the coolant pump 57. The coolant pump 57 causes the coolant to circulate inside a coolant circulation circuit. The coolant circulation circuit includes the coolant supply flow path 122, an internal coolant flow path of the fuel cell 30, the coolant discharge flow path 121, and the radiator 67.

The components of the fuel cell system 14, the power conversion device 28, the motor generator 18, and the power storage device 16 described above are controlled in an integrated manner by the control device 26.

It should be noted that the inlet-side stop valve 69, the outlet-side stop valve 71, the bypass valve 73, and the drain valve 50 are flow rate adjusting valves whose opening degrees are controlled by the control device 26, but the duty thereof may also be controlled using electromagnetically controlled on-off valves.

The fuel cell system 14 includes the auxiliary devices (the auxiliary device) 42 consuming electric power generated by the fuel cell 30. The control unit 84 may perform control such that the amount of electric power generated by the fuel cell 30 is equal (substantially equal) to the amount of electric power consumed by the auxiliary devices 42.

Performing control in this manner eliminates the need to charge the power storage device 16 with the surplus electric power generated by the fuel cell system 14. Therefore, the fuel cell system 14 can be operated without acquiring information relating to the current remaining capacity SOCn of the power storage device 16.

The auxiliary devices 42 included in the fuel cell system 14 may be any one of the air pump 55 that supplies the oxygen-containing gas to the fuel cell 30, the coolant pump 57 provided in the coolant flow path 120 configured to cool the fuel cell 30, the fuel circulation pump 56 provided in the circulation flow path 78 configured to circulate the fuel gas to the fuel cell 30, and the heat dissipation heater 58 that dissipates the electric power generated by the fuel cell 30 into the atmosphere as heat. As a result, it is possible to effectively consume the electric power generated by the fuel cell system 14.

The control device 26 is a computer provided in the vehicle 10. The control device 26 includes a computation unit 80, a storage unit 81, a peripheral device 82, and a display unit (not shown) and an operation unit (not shown) connected to the peripheral device 82.

The computation unit 80 can be constituted by a processor such as a CPU or a GPU. That is, the computation unit 80 can be constituted by processing circuitry.

The computation unit 80 includes a determination unit 83 and the charge/discharge control unit 84. The determination unit 83 and the charge/discharge control unit 84 can be realized by the processor constituting the computation unit 80 executing a program stored in the storage unit 81.

The peripheral device 82 performs processing such as measuring time and converting an analog signal into digital data to be taken in, in addition to input/output processing of digital data to and from the components constituting the vehicle 10.

It should be noted that at least part of the peripheral device 82, the determination unit 83, and the control unit 84 may be realized by an integrated circuit such as an ASIC or an FPGA. Further, at least part of the peripheral device 82, the determination unit 83, and the control unit 84 may be constituted by an electronic circuit including a discrete device.

The storage unit 81 can be constituted by a volatile memory and a non-volatile memory. Examples of the volatile memory may include a RAM and the like. The volatile memory is used as a working memory of the processor and temporarily stores data and the like required for processing or computation. Examples of the non-volatile memory may include a ROM, a flash memory, and the like. The non-volatile memory is used as a storage memory and stores programs, tables, maps, and the like. At least a part of the storage unit 81 may be included in the processor, the integrated circuit, or the like described above.

The computation unit 80 of the control device 26 executes calculation according to the program to control the operation of the vehicle 10 and the fuel cell system 14.

A power switch (power SW) 79 of the vehicle 10 is connected to the control device 26. The power switch 79 causes the electric power generation operation of the fuel cell 30 of the fuel cell system 14 to be started or continued (ON), or to be terminated (OFF). An unillustrated accelerator operation amount sensor that detects an operation amount of an accelerator pedal and an unillustrated vehicle speed sensor that detects a vehicle speed of the vehicle 10 are also connected to the control device 26.

Note that the storage unit 81 stores a predicted regenerative electric power amount in a combined control section Msc described later. The predicted regenerative electric power amount is calculated by the computation unit 80 based on position altitude information obtained from the navigation device 24, or based on information acquired by an inclination sensor or an altitude sensor when the vehicle has traveled along the planned travel route Dp in advance.

### Operation

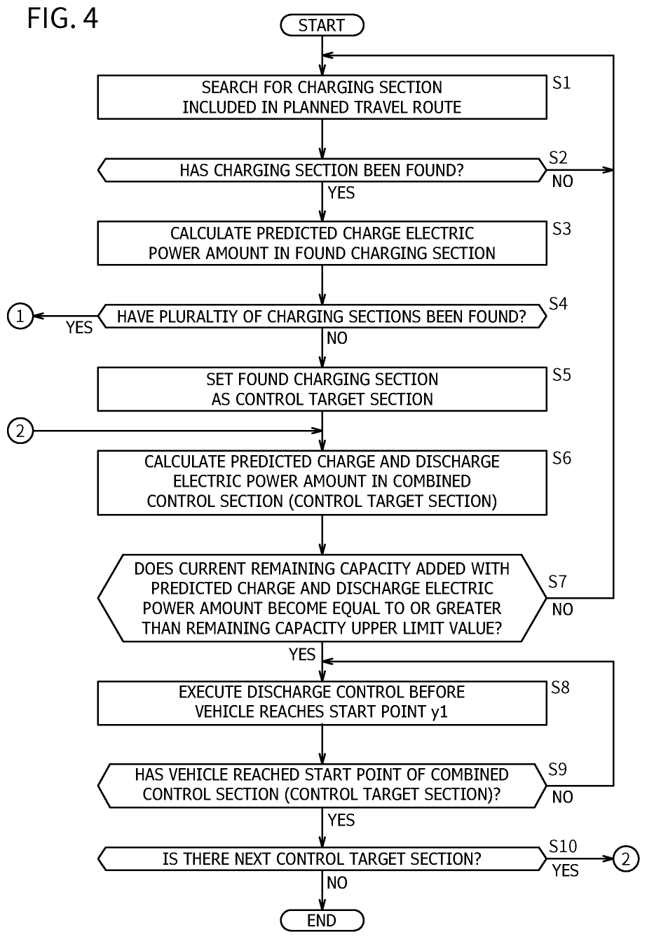

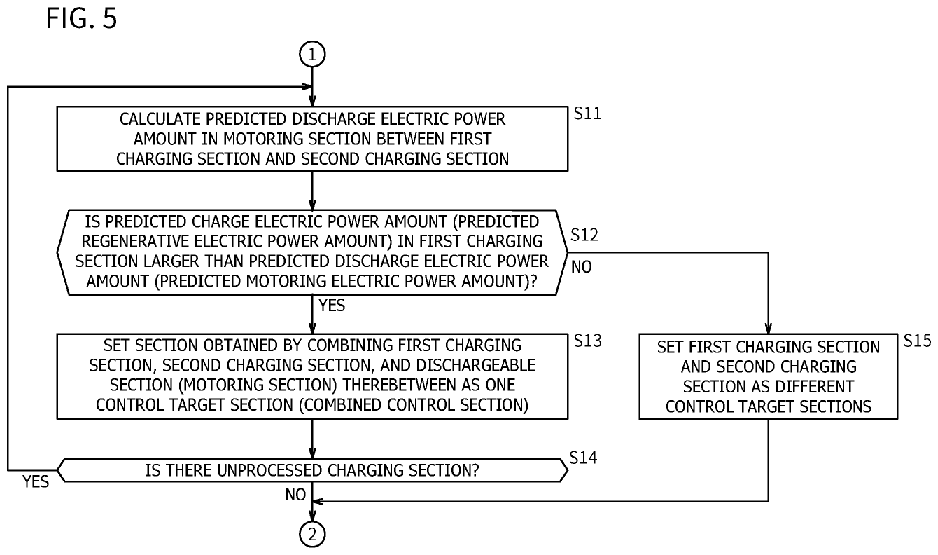

The control device 26 of the vehicle 10 according to the embodiment is basically configured as described above. Hereinafter, with reference to the flowcharts of FIGS. 4 and 5, the processing operation of the charge/discharge control unit 84 performed on the power storage device 16 during the motoring operation and the regenerative operation will be described, taking the forward traveling of the vehicle 10 in the ON state of the power switch 79 as an example.

### Planned Travel Route Dp

Before describing the operation with reference to the flowcharts, the planned travel route Dp of the vehicle 10 will be described.

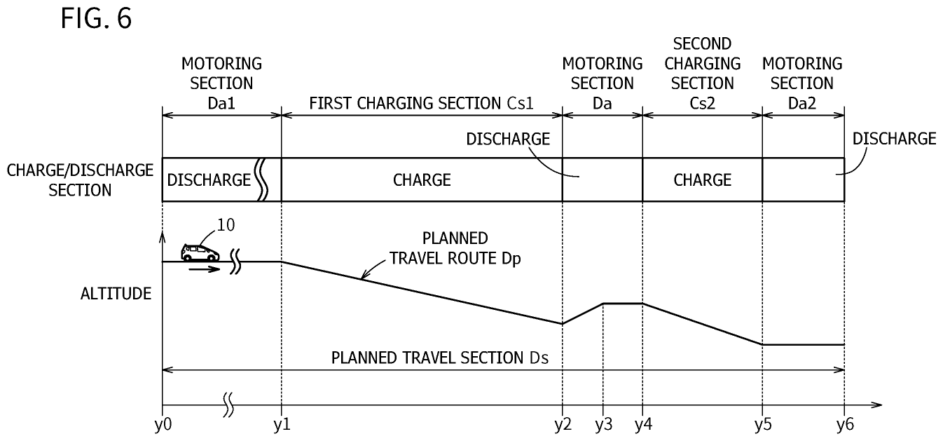

FIG. 6 is a distance-altitude schematic diagram showing a change in altitude of the planned travel route Dp and the like. The planned travel route Dp to be allotted to the planned travel section Ds is set when, for example, the user inputs a destination (travel end point) y6 to the navigation device 24 at a travel start point y0 of the vehicle 10. In FIG. 6, for ease of understanding, the planned travel route Dp is assumed to be a straight road from the travel start point y0 to the travel end point y6.

In FIG. 6, the vehicle 10 located at a high altitude travels on a flat road (in a motoring section Da1) from the travel start point y0 to a point y1 in the planned travel route Dp. Next, from the point y1 to a point y2, the vehicle 10 travels on a downhill road (in a first charging section Cs1) where electric power can be regenerated by the motor generator 18. On this downhill road, regenerative braking is performed in the vehicle 10. Next, the vehicle 10 travels on an uphill road (in a part of a motoring section Da) from the point y2 to a point y3. Next, the vehicle 10 travels on a flat road (in the remaining portion of the motoring section Da) from the point y3 to a point y4. Next, from the point y4 to a point y5, the vehicle 10 travels on a downhill road (in a second charging section Cs2) where electric power can be regenerated by the motor generator 18. On this downhill road as well, regenerative braking is performed in the vehicle 10. Next, the vehicle 10 travels on a flat road (in a motoring section Da2) from the point y5 to the travel end point y6.

The first charging section Cs1 is a charging section closest to the vehicle 10 in the traveling direction of the vehicle 10 from the travel start point y0, within a regeneration section included in the planned travel route Dp of the vehicle 10. Further, the second charging section Cs2 is a charging section closest to the first charging section Cs1 in the traveling direction of the vehicle 10, within the regeneration section included in the planned travel route Dp of the vehicle 10.

### Flowcharts

In step S1 of FIG. 4, the control unit 84 searches for a charging section, which is a regeneration section of the motor generator 18 and included in the planned travel route Dp of the vehicle 10, based on the route information received from the navigation device 24 based on the user setting, and advances the process to step S2.

In step S2, the control unit 84 determines whether or not the charging section (regeneration section) where the regenerative operation of the motor generator 18 is executed is found in the planned travel route Dp.

In the case where the charging section is not found (S2: NO), the control unit 84 returns the process to step S1 and repeats the process. In the case where the charging section is found (S2: YES), the control unit 84 advances the process to step S3. In step S3, the control unit 84 calculates a predicted charge electric power amount [kWh] in the charging section that has been found.

Note that a plurality of charging sections may be found by the search process in step S1. In the case where a plurality of charging sections are found in this manner, then in step S3, the control unit 84 calculates the predicted charge electric power amount in each charging section that has been found, and advances the process to step S4.

In step S4, the control unit 84 determines whether or not a plurality of charging sections have been found by the process in step S1. In the case where a plurality of charging sections have not been found(S4: NO), that is, in the case where the number of charging sections found in the planned travel route Dp is one, the process is advanced to step S5.

In step S5, the control unit 84 sets this charging section as a control target section (a section to be controlled), and advances the process to step S6.

When it is determined in step S4 that a plurality of charging sections (the first charging section Cs1 and the second charging section Cs2 in this embodiment as shown in FIG. 6) have been found(S4: YES), the control unit 84 advances the process to step S11 in FIG. 5.

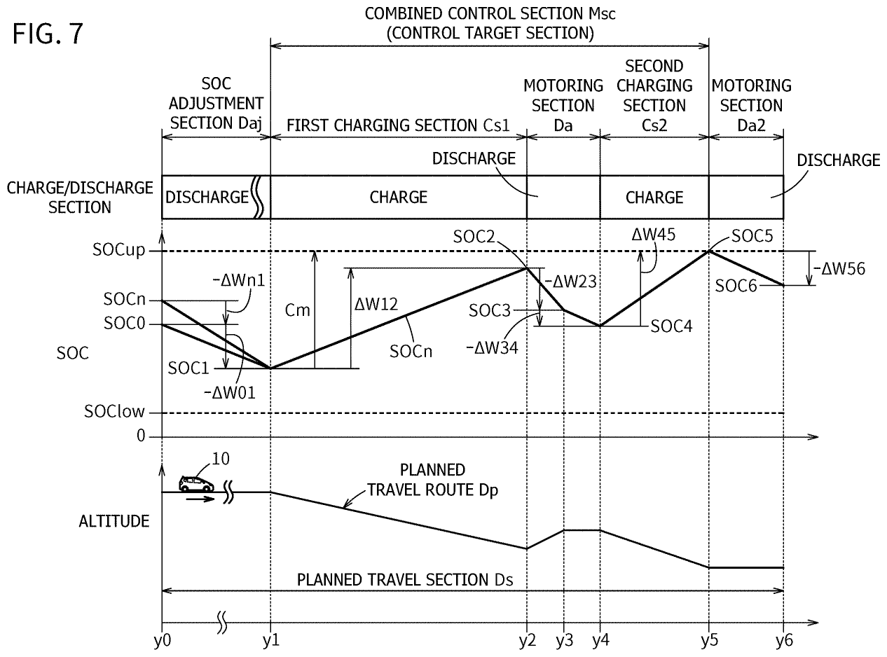

FIG. 7 is a schematic diagram of a change in remaining capacity over distance in which a change state of the remaining capacity of the power storage device 16 (an increment “+ΔW” of the remaining capacity and a decrement “−ΔW” of the remaining capacity) is added on the vertical axis in FIG. 6.

In step S11, the control unit 84 calculates a predicted discharge electric power amount in the motoring section Da between the first charging section Cs1 and the second charging section Cs2 as shown in Expression (6), and advances the process to step S12.

predicted discharge electric power amount=|(−ΔW23)+(−ΔW34)| (6)

In step S12, as shown in Expression (7), the control unit 84 determines whether or not a predicted charge electric power amount (predicted regenerative electric power amount) ΔW12 in the first charging section Cs1 is larger than a predicted discharge electric power amount (predicted motoring electric power amount) |(−ΔW23)+(−ΔW34)| in the motoring section Da obtained by the process in step S11. Note that the predicted charge electric power amounts ΔW12 and ΔW45 in the first charging section Cs1 and the second charging section Cs2 are values calculated in step S3 and stored in the storage unit 81.

ΔW12>|(−ΔW23)+(−ΔW34)| (7)

In the case where the predicted charge electric power amount ΔW12 in the first charging section Cs1 is smaller than the predicted discharge electric power amount |(−ΔW23)+(−ΔW34)| in the motoring section Da (S12: NO), the process is advanced to step S15. In step S15, the control unit 84 sets the first charging section Cs1 and the second charging section Cs2 as different control target sections, and returns the process to step S6.

In the case where the predicted charge electric power amount ΔW12 in the first charging section Cs1 is larger than the predicted discharge electric power amount |(−ΔW23)+(−ΔW34)| in the motoring section Da (S12: YES), the control unit 84 advances the process to step S13.

In step S13, the control unit 84 sets a section obtained by combining the first charging section Cs1, the second charging section Cs2, and the motoring section Da therebetween as one control target section (also referred to as a combined control section) Msc, and advances the process to step S14.

That is, in the case where the predicted charge electric power amount ΔW12 in the first charging section Cs1 (first regeneration section) is larger than the predicted discharge electric power amount |(−ΔW23)+(−ΔW34)| in the motoring section Da (S12: YES), then in step S13, the control unit 84 combines the first charging section (first regeneration section) Cs1, the motoring section Da, and the second charging section (second regeneration section) Cs2, and regards the combined section as the combined control section Msc in which charge and discharge control is performed on the power storage device 16.
[Maximum Value of Current Remaining Capacity SOCn at Points y2 and y5 as End Points of First Charging Section Cs1 and Second Charging Section Cs2]

As shown in FIG. 7, in order to avoid overcharging of the power storage device 16, the control unit 84 performs control such that the maximum value of the current remaining capacity SOCn at the end point y2 of the first charging section Cs1 and the end point y5 of the second charging section Cs2 (the point y5 that is the end point of the combined control section Msc) does not exceed the remaining capacity upper limit value SOCup (see also FIG. 2). Here, first, it is assumed that the current remaining capacity SOCn becomes the remaining capacity upper limit value SOCup at the point y5.

Then, in order to make it possible to charge the power storage device 16 with the predicted charge electric power amount ΔW45 obtained from the point y4 to the point y5 while the vehicle 10 is traveling, a remaining capacity SOC4 at the start point y4 of the second charging section Cs2 can be calculated as shown in Expression (8).

SOC4=SOC5(remaining capacity upper limit value SOCup)−ΔW45 (8)

Note that, by making it possible to charge the power storage device 16 with the predicted charge electric power amount ΔW45 while the vehicle 10 is traveling, the vehicle 10 can continue to apply the regenerative braking on the downhill road from the point y4 to the point y5.

A remaining capacity SOC2 at the point y2 can be calculated as shown in Expression (9) from the discharge amount (−ΔW23) in the motoring section Da from the point y2 to the point y3 and the discharge amount (−ΔW34) in the motoring section Da from the point y3 to the point y4 (|−ΔW23|>|−ΔW34|).

SOC2=SOC3+ΔW23=SOC4+ΔW34+ΔW23 (9)

In order to make it possible to charge the power storage device 16 with the predicted charge electric power amount ΔW12 obtained from the point y1 to the point y2 while the vehicle 10 is traveling, a remaining capacity SOC1 at the start point y1 of the first charging section Cs1 needs to be as shown in Expression (10).

SOC1=SOCpb 2−ΔW12 (10)

Note that, by making it possible to charge the power storage device 16 with the predicted charge electric power amount ΔW12 while the vehicle 10 is traveling, the vehicle 10 can continue to apply the regenerative braking on the downhill road from the point y1 to the point y2.The predicted discharge electric power amount in the motoring section (an SOC adjustment section Daj) from the point y0 to the point y1 is |−ΔW01|.

When the predicted discharge electric power amount |−ΔW01| is added to the remaining capacity SOC1 at the point y1, a remaining capacity SOC0 at the travel start point y0 becomes a value shown in Expression (11).

SOC0=SOC1+|−ΔW01| (11)

The current remaining capacity SOCn at the point y0 is larger than the remaining capacity SOC0.

A differential remaining capacity |−ΔWn1| shown in Expression (12) needs to be wasted during traveling from the point y0 to the point y1.

|−ΔWn1|=ΔWn1=SOCn−SOC0 (12)

In order to achieve this, the auxiliary devices 42 are operated with the electric power of the power storage device 16 regardless of the electric power generation of the fuel cell 30 and the electric power of the power storage device 16 is wasted. As a result, it is possible to waste the differential remaining capacity ΔWn1 while the vehicle 10 is traveling between the point y0 and the point y1 without changing the amount of electric power generated by the fuel cell 30. The amount of electric power generated by the fuel cell system 14 may be controlled so that the charge margin Cm remains.

Returning to the flowchart of FIG. 5, in step S14, the control unit 84 determines whether or not there is an unprocessed charging section (a charging section that is not set as a control target section) among the charging sections included in the planned travel route Dp of the vehicle 10.

If there is an unprocessed charging section (S14: YES), the control unit 84 returns the process to step S11 and executes the processes in step S11 and subsequent steps again.

If there is no unprocessed charging section (S14: NO), the control unit 84 advances the process to step S6 of the flowchart of FIG. 4.

In step S6, the control unit 84 calculates a predicted charge and discharge electric power amount Pec in the combined control section Msc (control target section), and then advances the process to step S7.

In step S7, the control unit 84 determines whether or not the current remaining capacity SOCn added with the predicted charge and discharge electric power amount Pec in the combined control section Msc (control target section)becomes equal to or greater than the remaining capacity upper limit value SOCup. In the case where the determination result is negative (S7: NO), the control device 26 returns the process to step S1 and continues the process. On the other hand, in the case where the determination result is positive (S7: YES), the control device 26 advances the process to step S8.

In step S8, the control device 26 executes the electric power wasting process (discharge control) for the differential remaining capacity |−ΔWn1| described with reference to Expression (12) from the travel start point y0 to the start point y1 of the combined control section Msc on the planned travel route Dp, and advances the process to step S9.

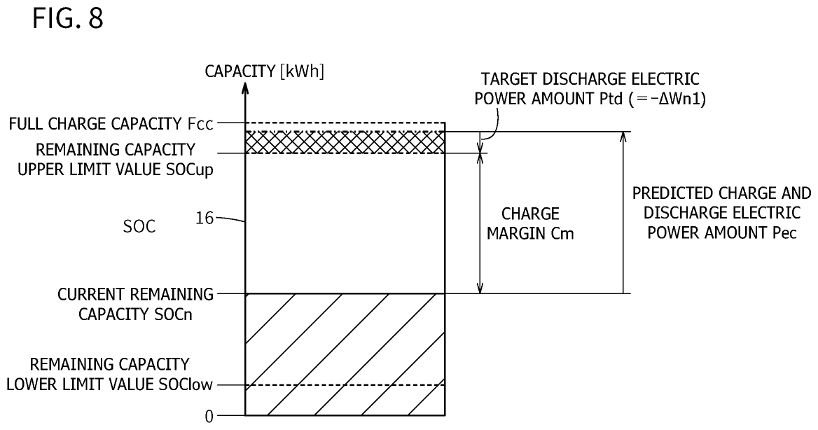

FIG. 8 is a schematic diagram showing an increase and decrease in the remaining capacity SOC for explaining how the charge margin Cm is secured by the electric power wasting process (discharge control) from the travel start point y0 to the start point y1 of the combined control section Msc on the planned travel route Dp.

The differential remaining capacity |−ΔWn1| indicated by the cross-hatched region is defined as a target discharge electric power amount Ptd. This target discharge electric power amount Ptd is a discharge amount by which the remaining capacity SOC obtained by adding the predicted charge and discharge electric power amount Pec in the combined control section Msc to the current remaining capacity SOCn becomes equal to or less than the remaining capacity upper limit value SOCup. As a result, the charge margin Cm in the power storage device 16 can be secured.

In step S9, the control device 26 determines whether or not the vehicle 10 has reached the start point y1 of the combined control section Msc (control target section).

In the case where the determination result is negative (S9: NO), the electric power wasting process (discharge control) in step S8 and the determination process in step S9 are repeatedly executed until a positive determination is made (S9: YES). In the case where the determination result is positive (step S9: YES), the control device 26 advances the process to step S10.

In step S10, the control device 26 determines whether or not there is a next control target section, and in the case where the determination result is positive (S10: YES), the control device 26 returns the process to step S6 and repeats the process. In the case where the determination result is negative (S10: NO), the process is ended.

Here, the vehicle 10 travels on the flat road (the motoring section Da2) from the point y5 to the travel end point y6. A remaining capacity SOC6 at the travel end point y6 is calculated by the expression SOC6=SOC5−ΔW56.

According to the above-described embodiment, the first charging section Cs1 ahead of the vehicle 10, the motoring section Da ahead of the first charging section Cs1, and the second charging section Cs2 ahead of the motoring section Da are combined and regarded as one combined control section Msc for the power storage device 16. As a result, discharge control or charge control that has been conventionally performed in each motoring section or each charging section can be performed collectively, and thus the complicated charge and discharge control can be simplified.

Further, when the vehicle 10 reaches the start point y1 of the combined control section Msc (the start point of the first charging section Cs1), control is performed such that the charge margin Cm remains in the power storage device 16 so that the power storage device 16 can be charged with the predicted regenerative electric power amount (the increments ΔW12, ΔW45) generated in the combined control section (the first charging section, the motoring section, and the second charging section) Msc.

Further, consuming electric power in the motoring section Da can eliminate the electric power that has been conventionally wasted without being charged into the power storage device 16 when the vehicle 10 passes through the combined control section Msc.

As a result, it is possible to reduce the amount of electric power generated by the fuel cell system 14, thereby improving the fuel efficiency (reducing fuel gas consumption) of the vehicle 10.

Further, the regenerative braking by the regenerative electric power generation of the motor generator 18 can be effectively used in all the charging sections (the first charging section Cs1 and the second charging section Cs2) of the combined control section Msc.

In the case where the vehicle 10 is a large vehicle such as a truck or a bus, the fuel cell systems 14 that can be easily connected in parallel are connected in parallel since the generated electric power is DC electric power. In this manner, in a large vehicle equipped with the fuel cell systems 14 connected in parallel, the frequency of use of a mechanical brake can be reduced, and stable traveling can be realized in the regeneration section.

### MODIFICATIONS

The above embodiment can also be modified as follows.

### Modification 1

In the above-described embodiment, a case was described in which the vehicle 10 is provided with the navigation device 24, but the present disclosure is not limited thereto. The navigation device 24 may be realized by a smartphone or the like that is provided so as to be able to communicate with the control device 26, and can notify the control device 26 of the planned travel route Dp of the vehicle 10 and the own vehicle position. Further, a part or all of the functions of the navigation device 24 may be realized by a server device outside the vehicle 10.

### Modification 2

The predicted charge and discharge electric power amount Pec in the combined control section Msc shown in FIG. 8 may be calculated based on the position altitude information obtained from the navigation device 24, or may be calculated based on the information acquired by the inclination sensor or the altitude sensor when the vehicle has traveled along the planned travel route Dp in advance.

In this manner, by acquiring the information about the altitude of the planned travel route Dp, the predicted charge and discharge electric power amount Pec in the combined control section Msc can be reliably acquired.

### Modification 3

When the discharge control is performed before the start point y1 of the combined control section Msc in step S8, the control unit 84 calculates a required arrival time Tr required until the vehicle 10 reaches the start point y1, based on the distance, the vehicle speed, and the like from the own vehicle position (point y0) to the start point y1.

The control unit 84 may perform discharging with a discharge electric power amount per unit time (Ptd/Tr) obtained by dividing the target discharge electric power amount Ptd by the required arrival time Tr.

As a result, the control unit 84 can suppress a situation in which a large current is discharged from the power storage device 16 at once. In this manner, the target discharge electric power amount Ptd of the power storage device 16 can be gradually discharged while suppressing deterioration of the power storage device 16 and unstable behavior of the vehicle 10.

Further, the control unit 84 may execute (start) the discharge control on condition that the above-described discharge electric power amount per unit time (Ptd/Tr) reaches a threshold. As a result, the control unit 84 can execute the discharge control after the vehicle 10 sufficiently approaches the combined control section Msc.

If the discharge control is executed before the vehicle 10 sufficiently approaches the combined control section Msc, a situation may occur in which the vehicle 10 deviates from the planned travel route Dp and does not travel in the combined control section Msc for some reason even though the discharge control is executed. In contrast, as described above, by executing the discharge control after the vehicle 10 sufficiently approaches the combined control section Msc, it is possible to suppress the occurrence of a situation in which the regenerative electric power cannot be obtained in the first charging section Cs1 and the current remaining capacity SOCn of the power storage device 16 cannot be increased.

### Supplementary Note

The following supplementary notes are further disclosed in relation to the above-described disclosure.

### Supplementary Note 1

The present disclosure is characterized by the control device 26 for the vehicle 10, the vehicle including: the fuel cell system 14 including the fuel cell 30 configured to generate electric power by using an oxygen-containing gas and a fuel gas; the motor generator 18 driven by electric power that is generated by the fuel cell system 14, the motor generator being configured to consume motoring electric power; the power storage device 16 configured to be charged with the electric power generated by the fuel cell system and regenerative electric power generated by the motor generator during regenerative braking; and the charge/discharge control unit 84 configured to control the electric power generated by the fuel cell system, the motoring electric power of the motor generator, the regenerative electric power of the motor generator, the remaining capacity SOC of the power storage device, and the charge and discharge electric power amount of the power storage device, wherein in a case where the planned travel route Dpof the vehicle includes the first charging section Cs1 which is located ahead of the vehicle and in which the motor generator generates the regenerative electric power, the motoring section Da which is located ahead of the first charging section and in which the motor generator consumes the motoring electric power, and the second charging section Cs2 which is located ahead of the motoring section and in which the motor generator generates the regenerative electric power, the charge/discharge control unit regards a section obtained by combining the first charging section, the motoring section, and the second charging section as the combined control section Msc in which charge and discharge control is performed on the power storage device, in a case where the predicted regenerative electric power amount ΔW12 in the first charging section is larger than the predicted motoring electric power amount (|−ΔW23|+|−ΔW34|) in the motoring section, and before the vehicle reaches the start point y1 of the combined control section, the charge/discharge control unit controls an amount of the electric power generated by the fuel cell system based on the predicted charge and discharge electric power amount Pec in the combined control section, in a manner so that the charge margin Cm allowing the power storage device to be charged with the predicted regenerative electric power amount in the combined control section remains in the power storage device.

By performing processing for the combined control section Msc, the discharge control or the charge control, which has been conventionally performed in each section (the motoring section or the charging section), can be performed collectively, and thus the complicated charge and discharge control can be simplified.

In addition, the regenerative braking by the regenerative electric power generation of the motor generator can be effectively used in all the charging sections (the first charging section and the second charging section) of the combined control section Msc.

For example, the frequency of use of a mechanical brake in a large vehicle equipped with fuel cell systems that can be easily connected in parallel can be reduced, and stable traveling can be realized in the regeneration section.

### Supplementary Note 2

In the control device for the vehicle according to Supplementary Note 1, before the vehicle reaches the start point of the combined control section, the charge/discharge control unit may limit the amount of the electric power generated by the fuel cell system in a manner so that the remaining capacity of the power storage device becomes equal to or less than a charge amount obtained by subtracting the predicted regenerative electric power amount in the combined control section from the full charge capacity Fcc of the power storage device.

According to this feature, by limiting the amount of the electric power generated by the fuel cell system before the vehicle reaches the start point of the combined control section, the fuel efficiency of the vehicle can be improved. In this case, the electric power generation time of the fuel cell is reduced, and the life of the fuel cell can be extended.

### Supplementary Note 3

In the control device for the vehicle according to Supplementary Note 1, before the vehicle reaches the start point of the combined control section, the charge/discharge control unit may limit the amount of the electric power generated by the fuel cell system in a manner so that the remaining capacity of the power storage device becomes equal to or less than a charge amount obtained by subtracting the predicted regenerative electric power amount in the combined control section from the remaining capacity upper limit value SOCup obtained by subtracting a margin from the full charge capacity of the power storage device.

According to this feature, by limiting the amount of the electric power generated by the fuel cell system before the vehicle reaches the start point of the combined control section, the fuel efficiency of the vehicle can be improved. In addition, the electric power generation time of the fuel cell is reduced, and the life of the fuel cell can be extended.

### Supplementary Note 4

In the control device for the vehicle according to Supplementary Note 1, the fuel cell system may include: the oxygen-containing gas supply flow path 68 configured to supply the oxygen-containing gas pressurized by the air pump 55 to the fuel cell; the discharge flow path 74 configured to discharge the oxygen-containing gas that has been partially consumed from the fuel cell; and the bypass flow path 72 configured to bypass the oxygen-containing gas from the oxygen-containing gas supply flow path to the discharge flow path, wherein the charge/discharge control unit may limit the amount of the electric power generated by the fuel cell system by causing the oxygen-containing gas pressurized by the air pump to flow via the bypass flow path.

According to this feature, by causing a portion of the oxygen-containing gas supplied to the fuel cell to flow through the bypass flow path, the amount of oxygen-containing gas supplied for use in electric power generation is reduced (and the amount of hydrogen consumed is also reduced at the same time), and by consuming (wasting) the amount of the electric power generated by the fuel cell with the air pump, the amount of the electric power generated by the fuel cell system can be limited.

### Supplementary Note 5

In the control device for the vehicle according to Supplementary Note 1, the fuel cell system may include the auxiliary device 42 configured to consume electric power generated by the fuel cell, wherein the charge/discharge control unit may perform control in a manner so that the amount of the electric power generated by the fuel cell is equal to the amount of electric power consumed by the auxiliary device.

This feature eliminates the need to charge the power storage device with the surplus electric power generated by the fuel cell system. Therefore, the fuel cell system can be operated without acquiring information relating to the remaining capacity of the power storage device.

### Supplementary Note 6

In the control device for the vehicle according to Supplementary Note 5, the auxiliary device included in the fuel cell system may be any one of the air pump configured to supply the oxygen-containing gas to the fuel cell, the coolant pump 57 provided in the coolant flow path 120 configured to cool the fuel cell, the fuel circulation pump 56 provided in the circulation flow path 78 configured to circulate the fuel gas to the fuel cell, or the heat dissipation heater 58 configured to dissipate electric power generated by the fuel cell into the atmosphere as heat. According to this feature, the electric power generated by the fuel cell system can be effectively consumed by the auxiliary device.

### Supplementary Note 7

In the control device for the vehicle according to Supplementary Note 1, the predicted regenerative electric power amount in the combined control section may be calculated based on the position altitude information obtained from the navigation device 24, or may be calculated based on the information acquired by the inclination sensor or the altitude sensor when the vehicle has traveled along the planned travel route in advance.

In this manner, by acquiring the information about the altitude of the planned travel route, the predicted regenerative electric power amount in the combined control section can be reliably acquired.

### Supplementary Note 8

The present disclosure is characterized by the control method for the vehicle, the vehicle including: the fuel cell system including the fuel cell configured to generate electric power by using an oxygen-containing gas and a fuel gas; the motor generator driven by electric power that is generated by the fuel cell system, the motor generator being configured to consume motoring electric power; the power storage device configured to be charged with the electric power generated by the fuel cell system and regenerative electric power generated by the motor generator during regenerative braking; and the charge/discharge control unit configured to control the electric power generated by the fuel cell system, the motoring electric power of the motor generator, the regenerative electric power of the motor generator, the remaining capacity of the power storage device, and the charge and discharge electric power amount of the power storage device, the control method including, in a case where the planned travel route of the vehicle includes the first charging section which is located ahead of the vehicle and in which the motor generator generates the regenerative electric power, the motoring section which is located ahead of the first charging section and in which the motor generator consumes the motoring electric power, and the second charging section which is located ahead of the motoring section and in which the motor generator generates the regenerative electric power: a step of causing the charge/discharge control unit to regard a section obtained by combining the first charging section, the motoring section, and the second charging section as the combined control section in which charge and discharge control is performed on the power storage device, in a case where the predicted regenerative electric power amount in the first charging section is larger than the predicted motoring electric power amount in the motoring section; and a charge and discharge control step of, before the vehicle reaches the start point of the combined control section, causing the charge/discharge control unit to control an amount of the electric power generated by the fuel cell system based on the predicted charge and discharge electric power amount in the combined control section, in a manner so that the charge margin allowing the power storage device to be charged with the predicted regenerative electric power amount in the combined control section remains in the power storage device.

According to this feature, it is possible to simplify complicated charge and discharge control for the power storage device in a vehicle equipped with the fuel cell system.

The present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A control device for a vehicle,
the vehicle including:
a fuel cell system including a fuel cell configured to generate electric power by using an oxygen-containing gas and a fuel gas;
a motor generator driven by electric power that is generated by the fuel cell system, the motor generator being configured to consume motoring electric power; and
a power storage device configured to be charged with the electric power generated by the fuel cell system and regenerative electric power generated by the motor generator during regenerative braking,
the control device comprising one or more processors that execute computer-executable instructions stored in a memory,
wherein the one or more processors execute the computer-executable instructions to cause the control device to control the electric power generated by the fuel cell system, the motoring electric power of the motor generator, the regenerative electric power of the motor generator, a remaining capacity of the power storage device, and a charge and discharge electric power amount of the power storage device, and
in a case where a planned travel route of the vehicle includes a first charging section which is located ahead of the vehicle and in which the motor generator generates the regenerative electric power, a motoring section which is located ahead of the first charging section and in which the motor generator consumes the motoring electric power, and a second charging section which is located ahead of the motoring section and in which the motor generator generates the regenerative electric power, the one or more processors cause the control device to:
regard a section obtained by combining the first charging section, the motoring section, and the second charging section as a combined control section in which charge and discharge control is performed on the power storage device, in a case where a predicted regenerative electric power amount in the first charging section is larger than a predicted motoring electric power amount in the motoring section; and
before the vehicle reaches a start point of the combined control section, control an amount of the electric power generated by the fuel cell system based on a predicted charge and discharge electric power amount in the combined control section, in a manner so that a charge margin allowing the power storage device to be charged with the predicted regenerative electric power amount in the combined control section remains in the power storage device.

2. The control device for the vehicle according to claim 1, wherein
the one or more processors execute the computer-executable instructions to cause the control device to:
before the vehicle reaches the start point of the combined control section, limit the amount of the electric power generated by the fuel cell system in a manner so that the remaining capacity of the power storage device becomes equal to or less than a charge amount obtained by subtracting the predicted regenerative electric power amount in the combined control section from a full charge capacity of the power storage device.

3. The control device for the vehicle according to claim 1, wherein
the one or more processors execute the computer-executable instructions to cause the control device to:
before the vehicle reaches the start point of the combined control section, limit the amount of the electric power generated by the fuel cell system in a manner so that the remaining capacity of the power storage device becomes equal to or less than a charge amount obtained by subtracting the predicted regenerative electric power amount in the combined control section from a remaining capacity upper limit value obtained by subtracting a margin from a full charge capacity of the power storage device.

4. The control device for the vehicle according to claim 1, wherein
the fuel cell system includes:
an oxygen-containing gas supply flow path configured to supply the oxygen-containing gas pressurized by an air pump to the fuel cell;
a discharge flow path configured to discharge the oxygen-containing gas that has been partially consumed from the fuel cell; and
a bypass flow path configured to bypass the oxygen-containing gas from the oxygen-containing gas supply flow path to the discharge flow path, and
the one or more processors execute the computer-executable instructions to cause the control device to limit the amount of the electric power generated by the fuel cell system by causing the oxygen-containing gas pressurized by the air pump to flow via the bypass flow path.

5. The control device for the vehicle according to claim 1, wherein
the fuel cell system includes an auxiliary device configured to consume electric power generated by the fuel cell, and
the one or more processors execute the computer-executable instructions to cause the control device to perform control in a manner so that an amount of the electric power generated by the fuel cell is equal to an amount of electric power consumed by the auxiliary device.

6. The control device for the vehicle according to claim 5, wherein
the auxiliary device included in the fuel cell system is any one of an air pump configured to supply the oxygen-containing gas to the fuel cell, a coolant pump provided in a coolant flow path configured to cool the fuel cell, a fuel circulation pump provided in a circulation flow path configured to circulate the fuel gas to the fuel cell, or a heat dissipation heater configured to dissipate the electric power generated by the fuel cell into atmosphere as heat.

7. The control device for the vehicle according to claim 1, wherein
the one or more processors execute the computer-executable instructions to cause the control device to calculate the predicted regenerative electric power amount in the combined control section based on position altitude information obtained from a navigation device, or based on information acquired by an inclination sensor or an altitude sensor when the vehicle has traveled along the planned travel route in advance.

8. A control method for a vehicle executed by one or more processors,
the vehicle including:
a fuel cell system including a fuel cell configured to generate electric power by using an oxygen-containing gas and a fuel gas;
a motor generator driven by electric power that is generated by the fuel cell system, the motor generator being configured to consume motoring electric power; and
a power storage device configured to be charged with the electric power generated by the fuel cell system and regenerative electric power generated by the motor generator during regenerative braking,
the control method comprising:
controlling the electric power generated by the fuel cell system, the motoring electric power of the motor generator, the regenerative electric power of the motor generator, a remaining capacity of the power storage device, and a charge and discharge electric power amount of the power storage device;
in a case where a planned travel route of the vehicle includes a first charging section which is located ahead of the vehicle and in which the motor generator generates the regenerative electric power, a motoring section which is located ahead of the first charging section and in which the motor generator consumes the motoring electric power, and a second charging section which is located ahead of the motoring section and in which the motor generator generates the regenerative electric power,
regarding a section obtained by combining the first charging section, the motoring section, and the second charging section as a combined control section in which charge and discharge control is performed on the power storage device, in a case where a predicted regenerative electric power amount in the first charging section is larger than a predicted motoring electric power amount in the motoring section; and
before the vehicle reaches a start point of the combined control section, controlling an amount of the electric power generated by the fuel cell system based on a predicted charge and discharge electric power amount in the combined control section, in a manner so that a charge margin allowing the power storage device to be charged with the predicted regenerative electric power amount in the combined control section remains in the power storage device.

9. The control method for the vehicle according to claim 8, wherein
before the vehicle reaches the start point of the combined control section, the amount of the electric power generated by the fuel cell system is limited in a manner so that the remaining capacity of the power storage device becomes equal to or less than a charge amount obtained by subtracting the predicted regenerative electric power amount in the combined control section from a full charge capacity of the power storage device.

10. The control method for the vehicle according to claim 8, wherein
before the vehicle reaches the start point of the combined control section, the amount of the electric power generated by the fuel cell system is limited in a manner so that the remaining capacity of the power storage device becomes equal to or less than a charge amount obtained by subtracting the predicted regenerative electric power amount in the combined control section from a remaining capacity upper limit value obtained by subtracting a margin from a full charge capacity of the power storage device.
